(19) United States
(12) Patent Application Publication
(10) Pub. No.: US 2004/0113991 A1
(43) Pub. Date: Jun. 17, 2004

(54) Ink jet apparatus

(75) Inventors: Steven R. Slotto, Vancouver, WA (US); Brian E. Sonnichsen, Lake Oswego, OR (US); David L. Knierim, Wilsonville, OR (US)

Correspondence Address: Patent Documentation Center, Xerox Corporation, Xerox Square, 20th Floor, 100 Clinton Ave. S., Rochester, NY, 14644, US

(73) Assignee: Xerox Corporation

(21) Appl. No.: 10/321,239

(22) Filed: Dec. 16, 2002

(51) Int. Cl. B41J 2/045

(52) U.S. Cl. 347/68

(57) ABSTRACT

A drop emitting apparatus including a drop generator having a piezoelectric transducer, and a temperature sensor formed of the same material as the piezoelectric transducer.

### BACKGROUND OF THE DISCLOSURE

The subject disclosure is generally directed to ink jet printing, and more particularly to an ink jet apparatus that includes a temperature sensor.

Drop on demand ink jet technology for producing printed media has been employed in commercial products such as printers, plotters, and facsimile machines. Generally, an ink jet image is formed by selective placement on a receiver surface of ink drops emitted by a plurality of drop generators implemented in a printhead or a printhead assembly. For example, the printhead assembly and the receiver surface are caused to move relative to each other, and drop generators are controlled to emit drops at appropriate times, for example by an appropriate controller. The receiver surface can be a transfer surface or a print medium such as paper. In the case of a transfer surface, the image printed thereon is subsequently transferred to an output print medium such as paper.

It may be helpful to detect a temperature of the printhead in order to control a temperature of the printhead, for example.

### BRIEF DESCRIPTION OF DRAWINGS

FIG. 1 is a schematic block diagram of an embodiment of a drop-on-demand drop emitting apparatus.

FIG. 2 is a schematic block diagram of an embodiment of a drop generator that can be employed in the drop emitting apparatus of FIG. 1.

FIG. 3 is a schematic block diagram of an embodiment of a piezoelectric temperature sensor that can be employed in the drop emitting apparatus of FIG. 1.

FIG. 4 is graph schematically illustrating a capacitance versus temperature characteristic of the piezoelectric temperature sensor of FIG. 3.

FIG. 5 is a schematic elevational view of an embodiment of an ink jet printhead assembly.

FIG. 6 is a schematic plan view of an embodiment of a transducer layer of the ink jet printhead assembly of FIG. 5.

### DETAILED DESCRIPTION OF THE DISCLOSURE

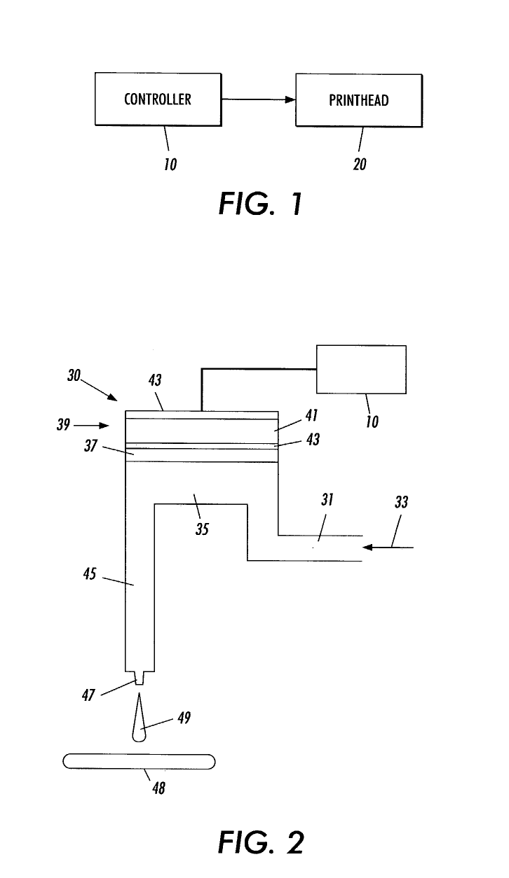

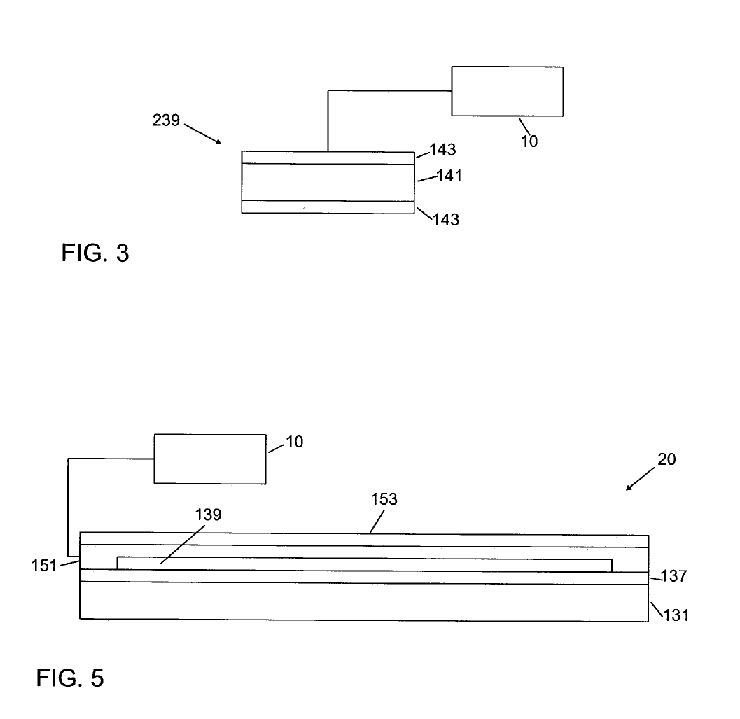

FIG. 1 is a schematic block diagram of an embodiment of a drop-on-demand printing apparatus that includes a controller 10 and a printhead assembly 20 that can include a plurality of drop emitting drop generators 30 (FIG. 2). The controller 10 selectively energizes the drop generators by providing a respective drive signal to each drop generator. Each of the drop generators employs a piezoelectric transducer 39 (FIG. 2) such as a ceramic piezoelectric transducer. By way of specific example, the piezoelectric transducer can comprise lead zirconium titanate (PZT). The printhead assembly further includes at least one piezoelectric temperature sensor 239 (FIG. 3) that comprises the same piezoelectric material as the piezoelectric transducers. A heater 153 (FIG. 5) is controlled by the controller 10 pursuant to temperature information provided by the piezoelectric temperature sensor 239.

FIG. 2 is a schematic block diagram of an embodiment of a drop generator 30 that can be employed in the printhead assembly 20 of the printing apparatus shown in FIG. 1. The drop generator 30 includes an inlet channel 31 that receives ink 33 from a manifold, reservoir or other ink containing structure. The ink 33 flows into a pressure or pump chamber 35 that is bounded on one side, for example, by a flexible diaphragm 37. A piezoelectric transducer 39 is attached to the flexible diaphragm 37 and can overlie the pressure chamber 35, for example. The piezoelectric transducer 39 includes a piezoelectric layer 41 disposed for example between electrodes 43 that receive drop firing and non-firing signals from the controller 10. The piezoelectric layer 41 can comprise lead zirconium titanate (PZT), for example. Actuation of the piezoelectric transducer 39 causes ink to flow from the pressure chamber 35 to a drop forming outlet channel 45, from which an ink drop 49 is emitted toward a receiver medium 48 that can be a transfer surface, for example. The outlet channel 45 can include a nozzle or orifice 47.

The ink 33 can be melted or phase changed solid ink, and the piezoelectric transducer can be operated in a bending mode, for example.

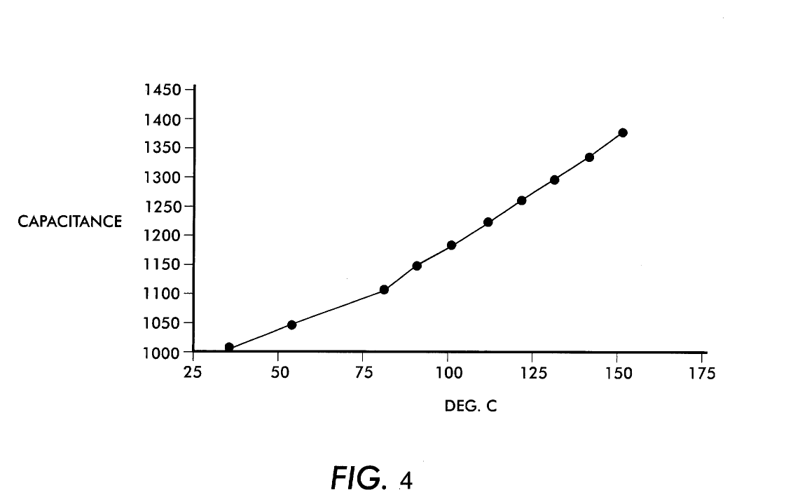

FIG. 3 is a schematic block diagram of an embodiment of a piezoelectric temperature sensor 239 that can be employed in the printhead assembly 20 of the printing apparatus shown in FIG. 1. The piezoelectric temperature sensor 239 includes a piezoelectric layer 141 disposed for example between electrodes 143 that provide temperature information to the controller 10. The piezoelectric temperature sensor 239 can be similar to the piezoelectric transducers 39 of the drop generators 30 (FIG. 2), and the piezoelectric layer 141 is of the same material as the piezoelectric layer 41 of the piezoelectric transducers 39. The capacitance of the piezoelectric temperature sensor 239 varies with temperature, as schematically illustrated in FIG. 4, and is sensed by the controller 10 to sense temperature and control a temperature of the printhead assembly 20.

FIG. 5 is a schematic elevational view of an embodiment of an ink jet printhead assembly 20 that can implement a plurality of drop generators 30 (FIG. 2), for example as an array of drop generators. The ink jet printhead assembly includes a fluid channel layer or substructure 131, a diaphragm layer 137 attached to the fluid channel layer 131, and transducer layer 139 attached to the diaphragm layer 137. The fluid channel layer 131 implements the fluid channels and chambers of the drop generators 30, while the diaphragm layer 137 implements the diaphragms 37 of the drop generators. The transducer layer 139 implements the piezoelectric transducers 39 of the drop generators 30 and at least one piezoelectric temperature sensor 239 (FIG. 3).

By way of illustrative example, the diaphragm layer 137 comprises a metal plate or sheet such as stainless steel that is attached or bonded to the fluid channel layer 131. Also by way of illustrative example, the fluid channel layer 131 can comprise multiple laminated plates or sheets.

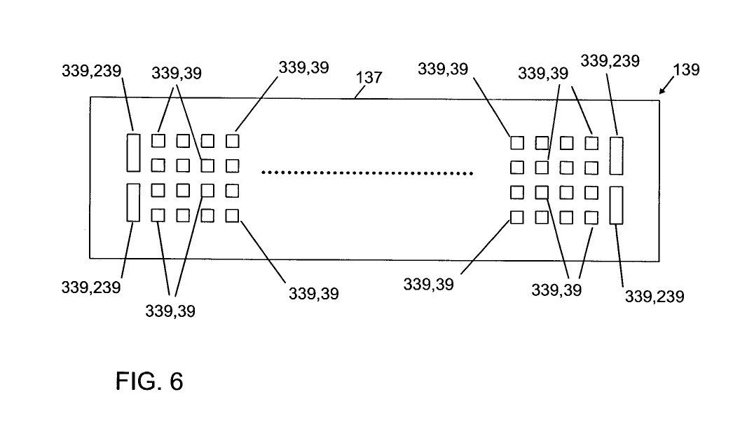

FIG. 6 is a schematic plan view of an embodiment of a transducer layer 139 that includes an array of piezoelectric circuit structures 339 each comprising a piezoelectric layer laminarly disposed between electrodes in substantially the same manner as the piezoelectric transducer 39 of FIG. 2 and the piezoelectric temperature sensor 239 of FIG. 3. The array of piezoelectric circuits 339 can be formed for example by kerfing a laminar structure comprised of a first electrode layer, a piezoelectric layer, and a second electrode layer. A plurality of the piezoelectric circuit structures 339 are employed as piezoelectric transducers 39 while at least one of the piezoelectric circuit structures 339 is employed as a piezoelectric temperature sensor 239. The array of piezoelectric circuits 339 can be generally rectangular, and piezoelectric sensors 239 can be located at one or both of the longitudinally separated ends of the array.

The printhead assembly 20 of FIG. 5 further includes an interconnect layer 151 that interconnects the piezoelectric transducers 39 and the temperature sensor 239 to the controller 10. A heater layer 153 can be disposed over the interconnect layer 151.

The invention has been described with reference to disclosed embodiments, and it will be appreciated that variations and modifications can be affected within the spirit and scope of the invention.

What is claimed is:

1. A drop emitting apparatus comprising:
a drop generator having a piezoelectric transducer; and
a temperature sensor formed of the same material as the piezoelectric transducer.

2. The drop emitting apparatus of claim 1 wherein the piezoelectric transducer comprises a piezoelectric material disposed between a first contact and a second contact.

3. The drop emitting apparatus of claim 1 wherein the temperature sensor comprises a piezoelectric material disposed between a first contact and a second contact.

4. The drop emitting apparatus of claim 1 wherein the piezoelectric transducer and the temperature sensor are formed by kerfing a laminar structure comprising a first contact layer, a second contact layer, and a piezoelectric layer disposed between the first contact layer and the second contact layer.

5. The drop emitting apparatus of claim 1 wherein the piezoelectric transducer and the temperature sensor comprise a ceramic material.

6. The drop emitting apparatus of claim 1 wherein the piezoelectric transducers and the temperature sensor comprise lead zirconium titanate.

7. The drop emitting apparatus of claim 1 further including a heater.

8. The drop emitting apparatus of claim 1 wherein the drop generator comprises a plurality of plates.

9. A drop emitting apparatus comprising:
a substrate having fluid channels and fluid chambers formed therein;
a plurality of piezoelectric transducers attached to the substrate; and
a temperature sensor formed of the same material as the piezoelectric transducers.

10. The drop emitting apparatus of claim 9 wherein each piezoelectric transducer comprises a piezoelectric material disposed between a first contact and a second contact.

11. The drop emitting apparatus of claim 9 wherein the temperature sensor comprises a piezoelectric material disposed between a first contact and a second contact.

12. The drop emitting apparatus of claim 9 wherein the piezoelectric transducers and the temperature sensor are formed by kerfing a laminar structure comprising a first contact layer, a second contact layer, and a piezoelectric layer disposed between the first contact layer and the second contact layer.

13. The drop emitting apparatus of claim 9 wherein the piezoelectric transducers and the temperature sensor comprise a ceramic material.

14. The drop emitting apparatus of claim 9 wherein the piezoelectric transducers and the temperature sensor comprise lead zirconium titanate.

15. The drop emitting apparatus of claim 9 further including a heater thermally coupled to the substrate.

16. The drop emitting apparatus of claim 9 wherein the substrate includes a diaphragm layer.

17. The drop emitting apparatus of claim 9 wherein the substrate includes a stainless steel diaphragm layer.

18. The drop emitting apparatus of claim 9 wherein the substrate comprises a plurality of plates.

19. A method of making a drop emitting apparatus comprising:
forming a substrate having fluid channels and fluid chambers; and
forming on the substrate a plurality of piezoelectric transducers of a predetermined piezoelectric material and a temperature sensor of the predetermined piezoelectric material.

20. The method of claim 19 further including thermally coupling a heater to the substrate.
